(19) United States
(12) Patent Application Publication
(10) Pub. No.: US 2019/0012728 A1
(43) Pub. Date: Jan. 10, 2019

(54) INTERACTIVE MOTOR VEHICLE COMPONENT IDENTIFICATION SYSTEM AND METHOD

(71) Applicant: Michael Horn, Port Austin, MI (US)

(72) Inventor: Michael Horn, Port Austin, MI (US)

(21) Appl. No.: 15/644,720

(22) Filed: Jul. 7, 2017

(51) Int. Cl. G06Q 30/06; G06Q 10/08; G06F 3/0481; G06F 3/0484

(52) U.S. Cl. CPC G06Q 30/0643; G06Q 10/087; G06F 3/04886; G06F 3/04815; G06F 3/04845; G06Q 30/0625

(57) ABSTRACT

A user-interactive parts database includes a server, a client device in communication with the server, and a user interface integral to the client device, and a database stored on the server. The database contains three-dimensional models of motor vehicles as well as component models for each vehicle. The models may be accessed and navigated using the user interface on the client device to find and identify a component. The user-interactive parts database is useful for identifying a vehicle component, especially when a customer does not know the name of the desired component.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicles of existing art and more specifically relates to vehicle parts databases.

### RELATED ART

When a part of a motor vehicle is damaged or becomes inoperative, often a consumer will visit a retail automotive parts store to obtain a new part. Retail automotive parts stores may have a vehicle component in stock or may order it from a warehouse. However, the component must first be identified using the make and model of the vehicle and the name of the part, or by using a part number.

Frequently a customer does not know the name of the part or the part number. This may occur because the customer has insufficient experience with the vehicle, especially if they are not the mechanic replacing the component. In this case, identifying the component the customer requires can be frustrating, as a retail employee must spend additional time helping the customer identify the component. In some cases, the wrong part may be ordered, or the part may not be able to be ordered at all. A suitable solution is desired.

U.S. Pub. No. 2005/0273229 to Eckhard Steinmeier et al. relates to a method and device for visualizing a vehicle repairing. The described method and device for visualizing a vehicle repairing includes a method for providing image data for visualizing a defective part and/or a repair process and/or a maintenance service of a road-bound vehicle, in particular a car or motorcycle. The aim is to reduce the translation costs for repair manuals. The method is characterized by the following: digital data is provided for at least two vehicle parts, in particular CAD data, vector data or another form of digital data suitable for visualizing is provided; digital data on the location of said two vehicle parts with respect to each other is also provided; a first selection element is provided for selecting a first repair operation from a plurality thereof, data, i.e., image data of the first stage of said first repair operation is provided.

### SUMMARY OF THE INVENTION

In view of the foregoing disadvantages inherent in the known vehicle parts database art, the present disclosure provides a novel interactive motor vehicle component identification system and method. The general purpose of the present disclosure, which will be described subsequently in greater detail, is to provide an interactive motor vehicle component identification system and method.

A user-interactive parts database is disclosed herein. The user-interactive parts database includes a server, a client device, a user interface, and a database. The user interactive parts database may be used to visually identify a component from a motor vehicle. The database is stored on the server and accessed though the client device, which is in communication with the server. The database on the server contains vehicle models as well as individual components for each model.

According to another embodiment, a method of identifying a vehicle component of a motor vehicle is also disclosed herein. The method of identifying a vehicle component of a motor vehicle includes providing a server, a client device connected to the server, a user interface on the client device, and a database hosted on the server; searching for a vehicle or component using the user interface; sending the search request to the server; displaying the requested vehicle or component on the client device; selecting the component desired; and identifying a part number associated with that component.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an interactive motor vehicle component identification system and method, constructed and operative according to the teachings of the present disclosure.

FIG. 1 is a perspective view of the user-interactive parts database during an ‘in-use’ condition, according to an embodiment of the disclosure.

FIG. 2 is a perspective view of the local area network of the user-interactive parts database of FIG. 1, according to an embodiment of the present disclosure.

FIG. 3 is a perspective view of the user interface of the user-interactive parts database of FIG. 1, according to an embodiment of the present disclosure.

FIG. 4 is a perspective view of the client device of the user-interactive parts database of FIG. 1, according to an embodiment of the present disclosure.

FIG. 5 is a flow diagram illustrating a method of use for visually identifying a vehicle component for purchase at a retail location, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle parts database and more particularly to an interactive motor vehicle component identification system and method as used to improve the efficiency and accuracy of parts ordering.

Generally, the interactive motor vehicle component identification system is a database designed to allow users to identify a specific part needed for repair/replacement and then receive the necessary information in regards to that part, such as name and parts number. The system may include a touch screen that allows users to zoom in and out on the images on the screen. It can be used at various stores to locate parts or for personal use on a tablet or smartphone. The images may be three-dimensional to enables the user to rotate the images and select various components. The device may have a menu of various categories, including automobile, agricultural equipment, appliances, and so forth. Each category will have a large number of selections to allow users to find the exact make and model of the machine they are working on. Once the desired selection is made, the user is able to rotate and zoom in as needed to locate the necessary component on the machine. The images may be ‘colored’ and taken from all angles and perspectives. Once the necessary part is identified, the device may provide information regarding the part, including name, part number, and location in store. An accompanying directory or pamphlet may also be included to assist users. Various embodiments may include databases having models and components representing automobiles, agricultural equipment, household appliances, industrial machinery, and other mechanical devices having serviceable components.

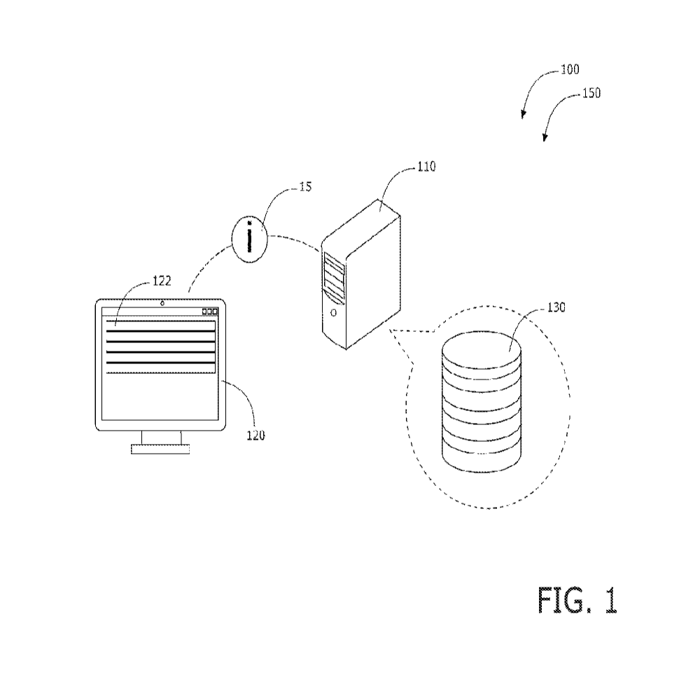

Referring now more specifically to the drawings by numerals of reference, there is shown in FIGS. 1-4, various views of a user-interactive parts database 100. FIG. 1 shows a user-interactive parts database 100 during an ‘in-use’ condition 50, according to an embodiment of the present disclosure. Here, the user-interactive parts database may be beneficial for use by a user 40 to visually identify a vehicle component for purchase at a retail location. As illustrated, the user-interactive parts database 100 may include server 110, client device 120, user interface 122, and database 130. Client device 120 is in communication with server 110. User interface 122 is integral to client device 120 and is configured to display information 15 retrieved from server 110 by client device 120. Database 130 is stored on server 110.

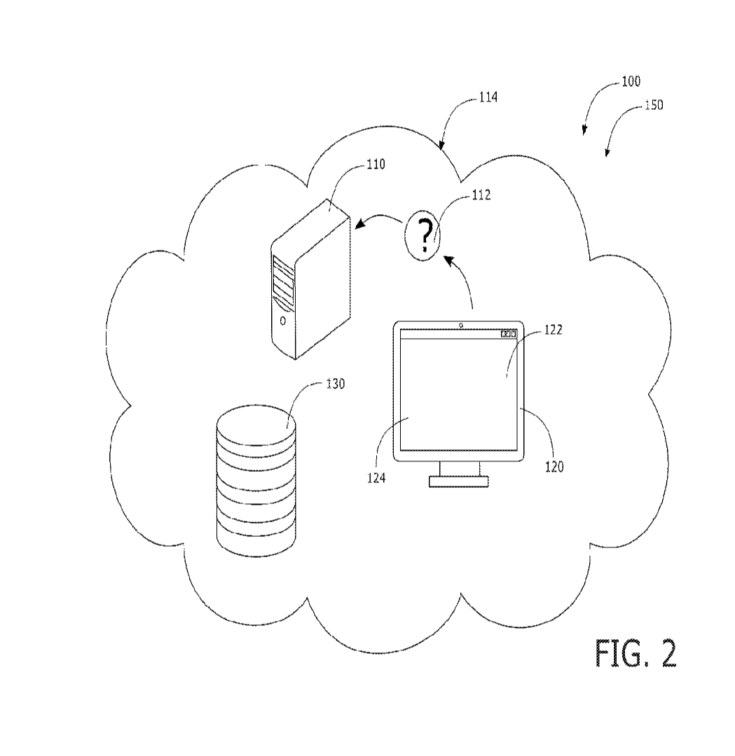

FIG. 2 shows the user-interactive parts database 100 of FIG. 1, according to an embodiment of the present disclosure. As above, the user-interactive parts database 100 may include server 110, client device 120, and database 130. Server 110 responds to queries 112 generated by client device 120. Server 110 includes a local area network 114.

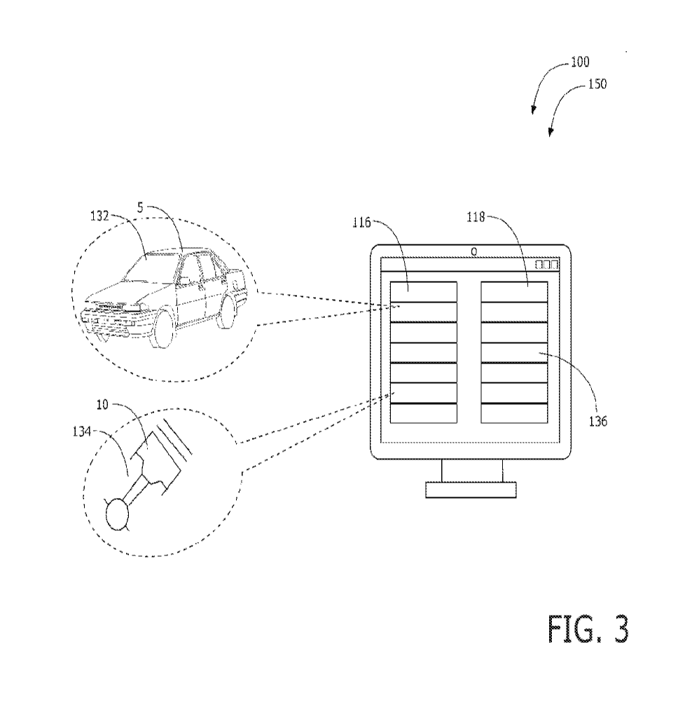

FIG. 3 is a perspective view of the user-interactive parts database 100 of FIG. 1 demonstrating user interface 122, according to an embodiment of the present disclosure. Display 124 is configured to display at least one virtual three-dimensional model 132 representing at least one motor vehicle 5 having a plurality of component models 134 representing at least one vehicle component 10. Display 124 may further display part number 136 corresponding to plurality of component models 134. Part number 136 corresponding to a selection of plurality of component models 134 is displayed on display 124 of user interface 122 when one of plurality of component models 134 is selected. At least one virtual three-dimensional model 132 is rotatable using user interface 122. Plurality of component models 134 is removable from at least one virtual three-dimensional model 132, plurality of component models 134 being configured to be viewable separately from at least one virtual three-dimensional model 132. At least one virtual three-dimensional model 132 is preferably colorized.

Each of plurality of component models 134 are manually selectable using user interface 122, and alternatively are selectable by entering part number 136 using user interface 122. User interface 122 further includes at least one vehicle menu 116, at least one vehicle menu 116 being configured to select motor vehicle 5. User interface 122 further includes at least one components menu 118, at least one components menu 118 being configured to select at least one vehicle component 10. At least one virtual three-dimensional model 132 may be converted to an exploded-view drawing 129, exploded-view drawing 129 being configured to exhibit plurality of component models 134.

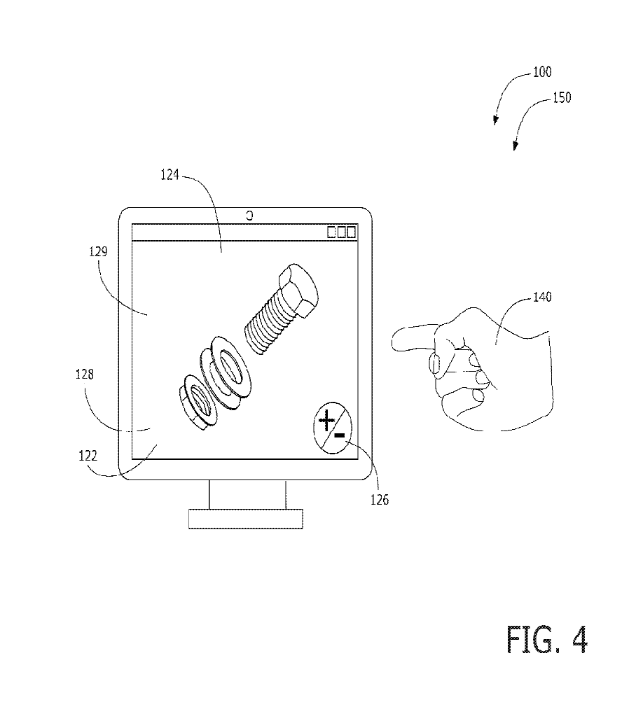

FIG. 4 is a perspective view of the user-interactive parts database 100 of FIG. 1, according to an embodiment of the present disclosure. User interface 122 includes a manually selectable scaling mechanism 126 configured to increase or decrease the size of at least one virtual three-dimensional model 132. Display 124 of user interface 122 is a touchscreen 128. Manually selectable scaling mechanism 126 is activated by tapping touchscreen 128 of user interface 122, manually selectable scaling mechanism 126 being configured to zoom in and alternatively zoom out where touchscreen 128 of user interface 122 has been tapped. Upon reading this specification, it should be appreciated that, under appropriate circumstances, considering such issues as user preferences, design preference, structural requirements, marketing preferences, cost, available materials, technological advances, etc., other arrangements such as, for example, alternative network connections, alternative display types, etc., may be sufficient.

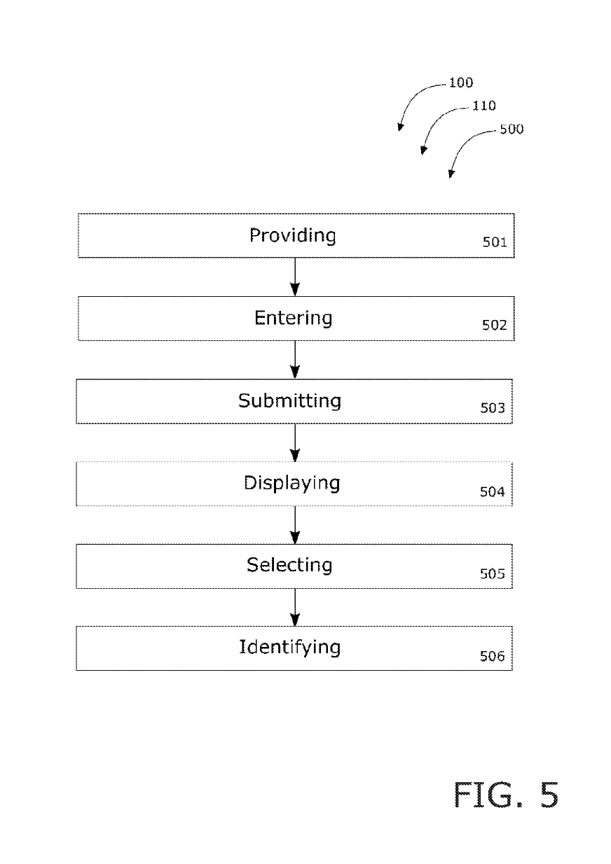

FIG. 5 is a flow diagram illustrating a method 500 for visually identifying a vehicle component for purchase at a retail location, according to an embodiment of the present disclosure. In particular, the method 500 for visually identifying a vehicle component for purchase at a retail location may include one or more components or features of the user-interactive parts database 100 as described above. As illustrated, the method 500 for visually identifying a vehicle component for purchase at a retail location may include the steps of: step one 501, Providing a server, a client device in communication with the server, a user interface configured to display information retrieved from the server by the client device; and a database stored on the server including at least one virtual three-dimensional model having a plurality of component models; step two 502, entering a query for the three-dimensional model and alternatively the at least one component into the client device using the user interface; step three 503, submitting the query to the server from the client device; step four 504, displaying the three-dimensional model and alternatively the at least one component on the display of the user interface; step five 505, selecting the component; and step six 506, identifying a part number corresponding to the component.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for visually identifying and ordering a vehicle component for purchase at a retail location, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A user-interactive parts database for visually identifying at least one vehicle component of at least one motor vehicle, the system comprising:
a server;
a client device in communication with the server;
a user interface including a display integral to the client device configured to display information retrieved from the server by the client device; and
a database stored on the server including at least one virtual three-dimensional model representing the at least one motor vehicle having a plurality of component models representing the at least one vehicle component.

2. The user-interactive parts database of claim 1, wherein the database further includes parts numbers corresponding to the plurality of component models.

3. The user-interactive parts database of claim 1, wherein the server responds to queries generated by the user interface.

4. The user-interactive parts database of claim 1, wherein the at least one virtual three-dimensional model is rotatable using the user interface.

5. The user-interactive parts database of claim 1, wherein the plurality of component models is removable from the three-dimensional model, the plurality of component models being configured to be viewable separately from the at least one virtual three-dimensional model.

6. The user-interactive parts database of claim 1, wherein each of the plurality of component models are manually selectable using the user interface.

7. The user-interactive parts database of claim 1, wherein each of the plurality of component models are selectable by entering the part number using the user interface.

8. The user-interactive parts database of claim 1, wherein the server includes a local area network.

9. The user-interactive parts database of claim 1, wherein the part number corresponding to a selection of the plurality of component models is displayed on the display of the user interface when the component is selected.

10. The user-interactive parts database of claim 1, wherein the user interface includes a manually selectable scaling mechanism configured to increase or decrease the size of the at least one virtual three-dimensional model.

11. The user-interactive parts database of claim 10, wherein the display of the user interface is a touchscreen.

12. The user-interactive parts database of claim 11, wherein the manually selectable scaling mechanism is activated by tapping the touchscreen of the user interface, the manually selectable scaling mechanism being configured to zoom in and alternatively zoom out where the touchscreen has been tapped.

13. The user-interactive parts database of claim 1, wherein the user interface further includes at least one vehicle menu, the at least one vehicle menu being configured to select the motor vehicle.

14. The user-interactive parts database of claim 1, wherein the user interface further includes at least one components menu, the at least one components menu being configured to select the at least one vehicle component.

15. The user-interactive parts database of claim 1, wherein the at least one virtual three-dimensional model may be converted to an exploded-view drawing, the exploded-view drawing being configured to exhibit the plurality of component models.

16. The user-interactive parts database of claim 1, wherein the at least one virtual three-dimensional model is colorized.

17. An user-interactive parts database with visual parts identification comprising:
a server;
a client device in communication with the server;
a user interface including a display integral to the client device configured to display information retrieved from the server by the client device; and
a database stored on the server including at least one virtual three-dimensional model representing the at least one motor vehicle having a plurality of component models representing the at least one vehicle component.
wherein the database further includes parts numbers corresponding to the plurality of component models;
wherein the server responds to queries generated by the user interface;
wherein the at least one virtual three-dimensional model is rotatable using the user interface;
wherein the plurality of component models is removable from the three-dimensional model, the plurality of component models being configured to be viewable separately from the at least one virtual three-dimensional model;
wherein each of the plurality of component models are manually selectable using the user interface;
wherein each of the plurality of component models are selectable by entering the part number using the user interface;
wherein the server includes a local area network;
wherein the part number corresponding to a selection of the plurality of component models is displayed on the display of the user interface when the component is selected;
wherein the user interface includes a manually selectable scaling mechanism configured to increase or decrease the size of the at least one virtual three-dimensional model;
wherein the display of the user interface is a touchscreen;
wherein the manually selectable scaling mechanism is activated by tapping the touchscreen of the user interface, the manually selectable scaling mechanism being configured to zoom in and alternatively zoom out where the touchscreen has been tapped;
wherein the user interface further includes at least one vehicle menu, the at least one vehicle menu being configured to select the motor vehicle;
wherein the user interface further includes at least one components menu, the at least one components menu being configured to select the at least one vehicle component;
wherein the at least one virtual three-dimensional model may be converted to an exploded-view drawing, the exploded-view drawing being configured to exhibit the plurality of component models; and
wherein the at least one virtual three-dimensional model is colorized.

18. A method of identifying a vehicle component of a motor vehicle, the method comprising the steps of:
providing a server, a client device in communication with the server, a user interface configured to display information retrieved from the server by the client device; and a database stored on the server including at least one virtual three-dimensional model having a plurality of component models;
entering a query for the three-dimensional model and alternatively the at least one component into the client device using the user interface;
submitting the query to the server from the client device;
displaying the three-dimensional model and alternatively the at least one component on the display of the user interface;
selecting the component; and
identifying a part number corresponding to the component.
